(19) United States
(12) Patent Application Publication
(10) Pub. No.: US 2007/0083855 A1
(43) Pub. Date: Apr. 12, 2007

(54) Method and apparatus to enhance context for specific instances of output text in source files

(76) Inventors: Sushma Bharat Patel, Austin, TX (US); Keiichi Yamamoto, Austin, TX (US); Kin Hung Yu, Austin, TX (US)

Correspondence Address: IBM CORP (YA);C/O YEE & ASSOCIATES PC, P.O. BOX 802333, DALLAS, TX, 75380, US

(21) Appl. No.: 11/245,303

(22) Filed: Oct. 6, 2005

(51) Int. Cl. G06F 9/44

(52) U.S. Cl. 717/127; 717/136

(57) ABSTRACT

A preprocessor places unique identifiers on each output phrase of a source code to produce a modified source code. Modified source code is exercised by test cases to produce a body of output images that are each added to digest files. A preprocessor character recognizes the images. This permits graphical representations of each instance of the output phrases to be traced to the source file from which the graphical representations originate. The output phrase and unique identifiers are added as text to each digest file so as to ease later search and retrieval of the image. A translator uses a matchtool to locate and display specific contextual images while editing the source file wherein the image is discovered by matching an output phrase in the source file with the text of a digest file.

### BACKGROUND OF THE INVENTION

1. Field of the Invention:

The present invention relates to generally computer program development and, in particular, to multiple language program development. Still more particularly, the present invention provides a method and computer usable code for delivering application context information to translators.

2. Description of the Related Art:

When translating a literary work, such as a novel, the context for creating an accurate translation is derived from the work and the translator's understanding of the work's setting. For example, history, culture, location, and socioeconomic strata are important contextual details that must be understood when translating a novel. Context is an all-important aspect for understanding the work to be translated and the basis from which an accurate translation arises, assuming the translator has the appropriate background and expertise.

Translation of software products is more difficult and compounded by a number of factors. The setting of an application lies in the interfaces that communicate with the user. A translator may have little experience with the program content and the actual interfaces from which the context is derived.

Often, software is developed using a development language, for example, English. A translator translates the output phrase of the development language to a target language, for example, French.

Translation difficulty is also compounded by the developer's use of good internationalization practice. By moving the human language out of the program interface and into resource files, the output phrase is disassociated from the interface. This leaves the translator to guess which text string in a file will be associated with which interface element.

### SUMMARY OF THE INVENTION

The aspects of the present invention provide a computer implemented method and computer usable code for associating a user interface image with an instance of an output phrase. A processor adds a unique identifier to each instance of an output phrase in a source file to form a modified source file. A processor executes the modified source file to obtain a resulting image having a graphical representation of the instance. The processor then stores the resulting image in a digest file. The processor derives or extracts instances of the output phrase derived from the output phrases wherein each phrase has a derived unique identifier. The processor finds the instance of the output phrase in the source file. The processor appends a derived unique identifier of the instance of the output phrase to the digest.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a pictorial representation of a data processing system in accordance with an illustrative embodiment of the present invention;

FIG. 2 shows a block diagram of a data processing system in accordance with an illustrative embodiment of the present invention;

FIG. 3A shows a preprocessor data processing system in accordance with an illustrative embodiment of the present invention;

FIG. 3B shows a data processing system in accordance with an illustrative embodiment of the present invention;

FIG. 4A shows a matching tool data processing system in accordance with an illustrative embodiment of the present invention;

FIG. 4B shows an alternative matching tool data processing system in accordance with an illustrative embodiment of the present invention;

FIG. 5 shows an example of a graphical user interface image used in accordance with an illustrative embodiment of the present invention;

FIG. 6 shows examples of excerpts from source files used in accordance with an illustrative embodiment of the present invention;

FIG. 7 shows examples of excerpts from program integrated information in accordance with an illustrative embodiment of the present invention;

FIG. 8 shows an annotated graphical user interface or resulting image used in accordance with an illustrative embodiment of the present invention;

FIG. 9 shows a digest in accordance with an illustrative embodiment of the present invention;

FIG. 10 shows a process for creating digest files in accordance with an illustrative embodiment of the present invention; and

FIG. 11 shows a process for collecting a user's translations of a source reference file in accordance with an illustrative embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented, is depicted in accordance with a preferred embodiment of the present invention. Computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

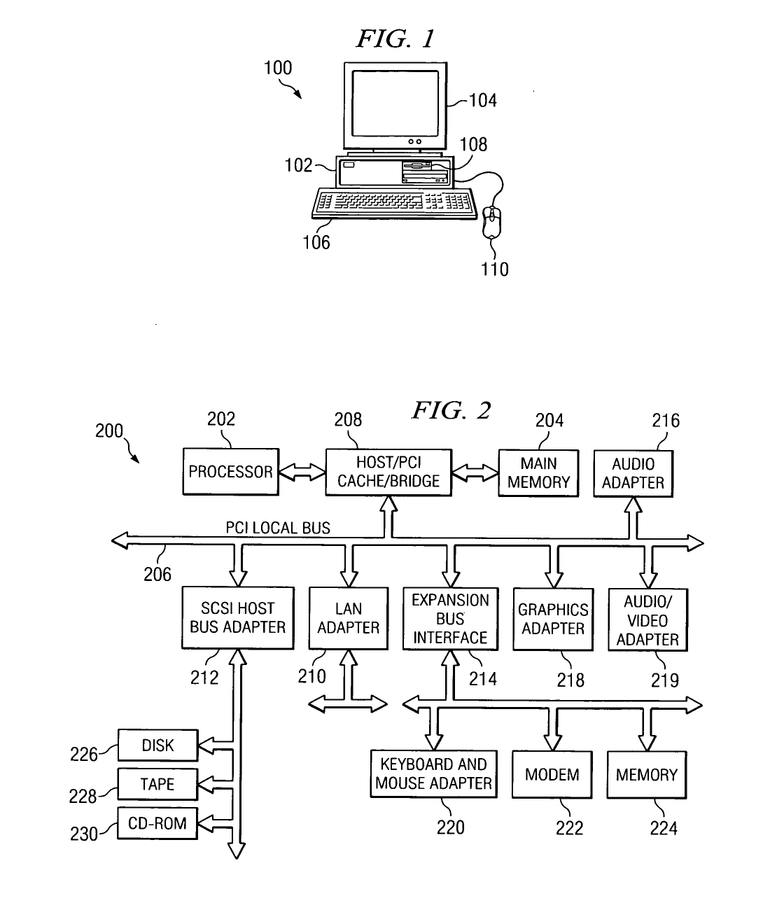

With reference now to FIG. 2, a block diagram of a data processing system is shown in which embodiments of the present invention may be implemented. Data processing system 200 is an example of a computer in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, and small computer system interface SCSI host bus adapter 212 are connected to PCI local bus 206 by direct component connection. In contrast, audio adapter 216, graphics adapter 218, and audio/video adapter 219 are connected to PCI local bus 206 by add-in boards inserted into expansion slots.

Expansion bus interface 214 provides a connection for keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft™ Corporation.

The various illustrative embodiments of the invention provide a mechanism to capture text from files output by the software in development, and to correlate specific instances of the output text to specific images in the output. This permits later retrieval, often a one-to-one correspondence, of an image when a translator reviews the software source code. Consequently, the contextual output is visible with few, if any, distracting irrelevant images being retrieved.

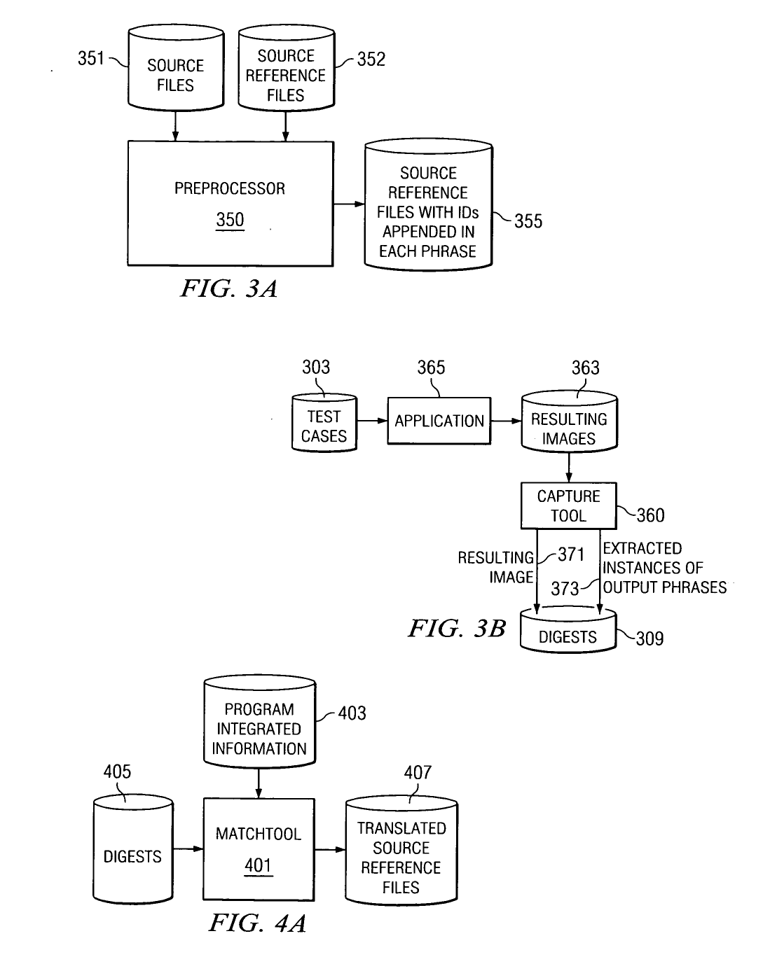

FIG. 3A shows a preprocessor data processing system in accordance with an illustrative embodiment of the present invention. Preprocessor 350 is a software tool that operates, for example, on processor 202 of FIG. 2.

A preliminary step performed by preprocessor 350 in these examples is to catalog each output phrase that may be embedded in source reference files, including files comprised of program integrated information. A source reference file, in one sense, is a program integrated information. Program integrated information includes all textual output that a program may display or otherwise render to a user during normal operations and recovery to normal operations. Typical program integrated information includes button labels, warnings, menu text and the like.

A source reference file, in a second sense, mixes the instructions of a source file together with the output phrases. In effect, a source reference file of the second sense is a kind of source file. An output phrase is a string of text that may be presented by a data processing system. This presentation is typically a display of the text, but may include other types of presentation in addition to or in place of displaying text. For example, a text to voice converter may be used to present the output phrase audibly to a user. A display connects, for example, to graphics adapter 218 of FIG. 2. Preprocessor 350, however, does not require a display in order to operate.

An output phrase includes strings of text that may have variables embedded therein. An output phrase may be text that has various counterparts in different languages, that is, the output phrase may be translatable. Preprocessing output phrases involves adding a unique identifier to each instance of each output phrase, in effect forming a kind of index. An instance is the occurrence of a particular word or phrase in a particular context of a source reference file. The same word may appear in multiple places of the source reference files. Each time the word appears is considered an instance, though a collection of words may also be an instance. The unique identifier may be comprised of a source reference file identifier, a separator, and an instance of the output phrase identifier. The source reference file identifier may be a serial number unique to the source reference file from which the instance originates. Similarly, the instance of the output phrase identifier may uniquely identify the instance of the output phrase in the source reference file. A separator may be a period.

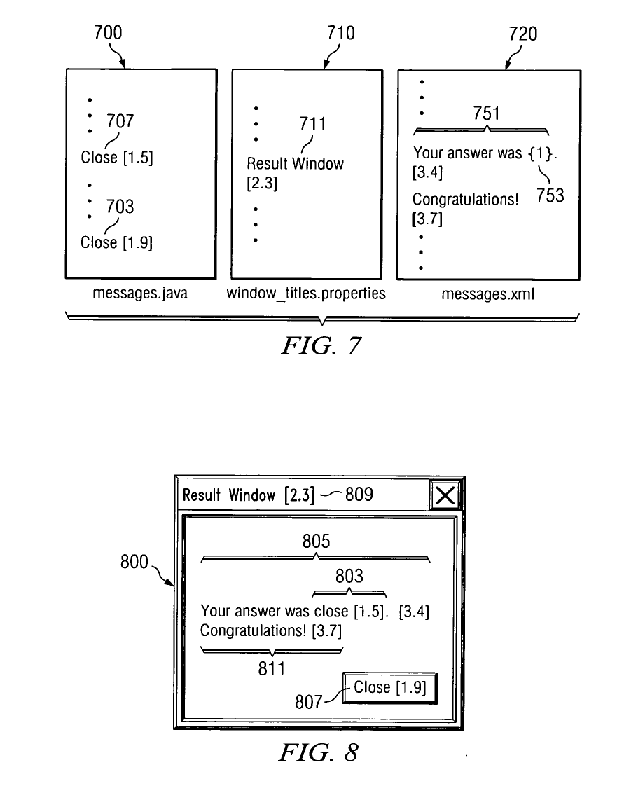

Thus, a unique identifier may be 5.9, signifying a source reference file associated with the number 5, and a ninth instance of an output phrase in that source reference file. For each source reference file processed in this manner, preprocessor 350 generates a corresponding modified source reference file 355. A modified source reference file is a source reference file that has changes made in the output phrases as compared to the originating source reference file. In short, preprocessor 350 operates source files in association with source reference files 352, which contain output phrases. Preprocessor provides modified source reference files 355 for later use. The modified source reference files 355 may be program integrated information. Examples of portions of program integrated information may be seen with reference to FIG. 7. Where developers embed output phrases into all source files, then all source files are also source reference files, and there is no distinction between such files. In such a case, source files 351 are identical to source reference files 352.

The source files as well as modified source reference files 355 may be executable in their present form in some environments. However, should the source files not be executable, preprocessor 350 may compile or otherwise build source files into executable files which may form an application. This permits the freshly added identifiers in each phrase to be readily executed and visibly verified.

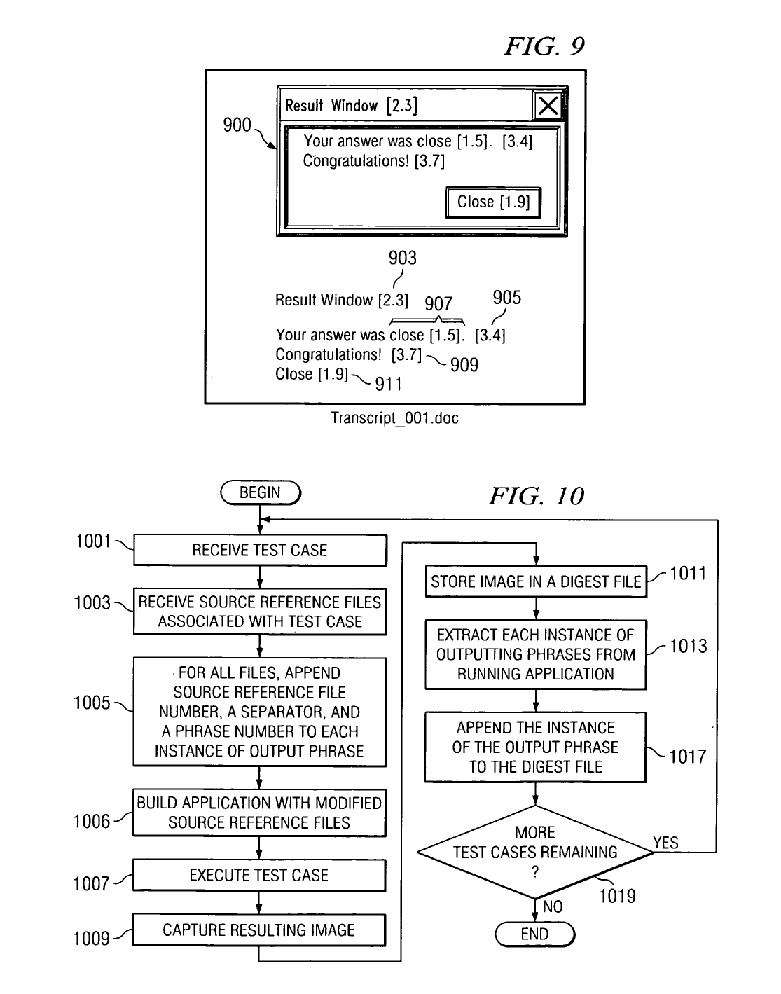

FIG. 3B shows a data processing system in accordance with an illustrative embodiment of the present invention. The second component preprocessor is capture tool 360. A processor may run test cases 303 using application 365. Application 365 may be the application compiled as described above into a single file. Alternatively, application 365 may be the collection of one or more source reference files that are, for example, source reference files with identifiers added to each phrase 355 of FIG. 3A. For each test case, application 365 may create resulting image 363. A processor need not actually display a resulting image. It is sufficient to create a resulting image by writing image data to a memory or other storage used to render graphics, such as, for example, as may exist in graphics adapter 218 of FIG. 2. The capture tool 360 may operate on the resulting image 363. Alternatively, capture tool 360 may extract information from an intermediate data that application 365 outputs prior to an operating system function rendering a resulting image. The information that capture tool extracts are derived instances of output phrases 373 wherein each derived instance has a derived unique identifier. Capture tool may append the derived instances of output phrases together with a resulting image 371 to form one or more digest files 309. An example of one of digest files 309 is shown in FIG. 9.

Each digest file is comprised of an image having graphical representations of each instance that produces an output under test case control. The graphical representation of an instance looks like the instance of the output phrase in a source reference file. However, the graphical representation may be modified in color, size and other ways to suit the tastes of the software developer. Moreover, the graphical representation is often a bitmap or image, and thus not directly amenable to textual searches known for their use in searching the Internet. In addition, the digest file has the actual text of each instance for which a graphical representation appears. Often, the actual text will be of several instances, and may be displayed as one instance to a line. Computers may search and match text at lower cost and in less time than searching and matching graphical representations of instances by hand. Thus, by providing an image with the text copies from the source files, the preprocessor obtains at least one resulting image associated with instances of source reference file output phrases.

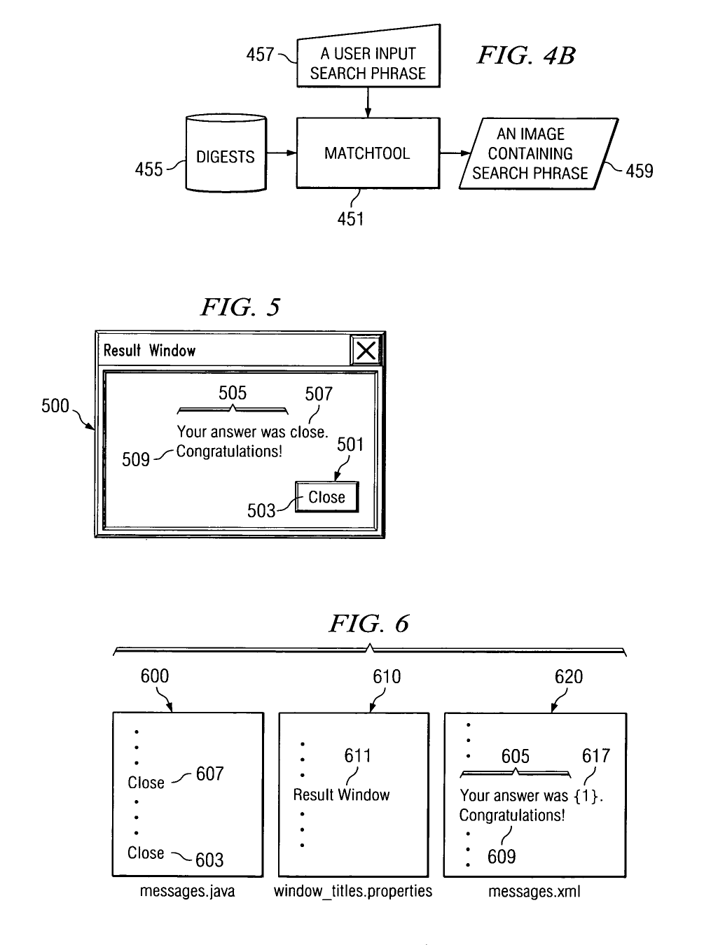

FIG. 4A shows a matching tool data processing system in accordance with an illustrative embodiment of the present invention. Matchtool 401 is a tool that permits a user or translator to review output phrases that occur in the source reference files. Matchtool 401 then selects each output phrase as search criteria. Matchtool 401 may operate on processor 202 of FIG. 2, for example. In this instance, program integrated information 403 may serve as the source reference file and the digest files 405 may serve as the field of search. Generally, a translator may look at each file of program integrated information 403 and in particular, at each output phrase in program integrated information 403. Looking may be orchestrated by various user interfaces that enhance focusing on the output phrases while minimizing the surrounding computer instructions, if any, or software development language. Looking may be straightforward in situations where program integrated information 403 is used as the source reference file. Looking can be more complicated when source reference files are comprised of instructions and output phrases. The computer instructions generally operate as a distraction to the translator, and generally, are not to be changed when a software-in-development is converted for use in different countries. It is appreciated that matchtool 401 may operate on the more generic source reference files that include instructions, instead of program integrated information 403.

The translator may use a search term that includes the unique identifier, wherein the translator provides a user-selected instance. When a translator triggers a search using matchtool 401, matchtool 401 may look in the digests 405 using the output phrase the translator selected as the search keyword. Matchtool 401 displays the matched images in the digests 405. Those images form the context in which the output phrases are used. In addition, matchtool 401 may provide a field where the translator may enter an appropriate translation. Still further, matchtool 401 may identify one or more former translations, provided the non-identifier portion of the search criteria had been translated previously. Previously translated criteria or words may be stored to a database by matchtool 401. For each translation the translator provides, matchtool 401 may store the machine instructions, if any, and the translated text to a translated source reference file 407.

FIG. 4B shows an alternative matching tool data processing system in accordance with an illustrative embodiment of the present invention. Alternative matchtool 451, like the matchtool 401 of FIG. 4A, relies on available digests 455 as a body of work to search. However, alternative matchtool 451 may interact with a user or translator by providing a search dialog box having, for example, a user input search field. A user may provide user input search phrase 457 and alternative matchtool 451 may receive the search phrase. Alternative matchtool 451 matches the search phrase against the text available in digests 455. If user input search phrase 457 is an instance with a unique identifier, the search may be very limited and return one matching digest. If the user provides fewer details concerning the instance, the search may return multiple matching digests. When the search is complete, alternative matchtool 451 provides an image containing the search phrase 459. At this point, the user has a context for the phrase searched, and may, in a separate window, replace an instance in a source reference file with the meaningful text in the target language.

FIG. 5 shows an example of a graphical user interface image used in accordance with an illustrative embodiment of the present invention. The graphical user interface, in this case, is dialog box 500. Dialog box 500 may be an intermediate file that a preprocessor creates and adds to a digest. For example, a preprocessor may be preprocessor 350 of FIG. 3A. Like most dialog boxes, a graphic is displayed that presents user-perceived button 501 for manipulation. User-perceived button may have an encircling boundary or a contrasting background to distinguish user-perceived button 501 from the remainder of dialog box 500. User-perceived button includes button text 503. A translator usually reviews button text 503 to translate when a translation language differs from the development language. For example, if the target language is Spanish, then a translator would select the word “cierra” to convey the meaning of the English verb “close”.

Dialog box 500 also has a message comprised of three parts: preface 505, first word 507, and second word 509. For example, first word 507 is “close”. Within the context of dialog box 500, first word 507 may translate to the Spanish, “cerca”, which is the equivalent of the English adjective, “near”.

FIG. 6 shows examples of excerpts from source reference files used in accordance with an illustrative embodiment of the present invention. These source reference files are only examples of the types of files that may operate as source reference files. Source reference files may include instructions, data, or both data and instructions. A preprocessor may use three source reference files to generate dialog 500: java file 600, properties file 610, and extended markup language file 620. Java file 600 may have two output phrase instances: first word output phrase 607 and button output phrase 603. Properties file 610 has an output phrase, for example, dialog title 611. Extended markup language file 620 has an output phrase, for example, preface 605, substitute text 617, and second word 609. An ellipsis in FIG. 6 may represent instructions, however, the ellipsis may simply be additional output phrases—particularly if the file contains purely program integrated information. A preprocessor, or other computer, may use such instructions to control the manner to display output phrase, for example, selecting a font size. Such instructions are highly functional, whereas the output phrases are highly expressive. Functional aspects tend to not require translation as software is adapted to operate for use in different cultures.

FIG. 7 shows examples of excerpts from modified source reference files in accordance with an illustrative embodiment of the present invention. A preprocessor converts source reference files to, for example, three modified source reference files: java file 700, properties file 710, and extended markup language file 720. The preprocessor tool appends the unique identifiers to each instance of a translatable output phrase. For example, the preprocessor tool modified “close” 607 in FIG. 6 to “close [1.5]” 707 in FIG. 7.

Embedded output phrase 751 includes substitute text reference 753. An embedded output phrase is an output phrase that contains a symbolic link or reference to a variable, resolvable at runtime, to text in a source reference file. Some instructions of extended markup language file 720 may show how to replace substitution text 753 when a processor executes or renders extended markup language file 720. A substitution text is the data stored at a memory or storage location described by substitution text reference 753, for example, indexed first word output phrase 707.

FIG. 8 shows an annotated graphical user interface or resulting image 800 used in accordance with an illustrative embodiment of the present invention. Each graphical representation of an instance is augmented in resulting image 800 with a unique identifier. Substitute text 803 is shown with associated unique identifier 1.5. Substitute text 803 is a part of embedded output phrase 805, which itself is associated with unique identifier 3.4. But for embodiments of the invention, an additional instance of the output phrase “close”, that is, button phrase 807 would be difficult to correlate with a source reference file. However, resulting image 800 includes unique identifier 1.9 to accompany button phrase “close” 807. Resulting image also includes graphical representations of instances including title 809, and second word 811, each including respective unique identifiers 2.3, and 3.7. Each unique identifier may include brackets “[”, and “]” to highlight that the enclosed characters represent a unique identifier.

FIG. 9 shows a digest or digest file in accordance with an illustrative embodiment of the present invention. Digest includes resulting image 900, also as depicted in FIG. 8. In addition, digest includes text searched and found by a capture tool: title text 903, embedded output phrase text 905, substitution text 907, second word text 909, and button text 911 of FIG. 9, corresponding to title 809, embedded output phrase 805, substitution text 803, second word 811, and button phrase 807 of FIG. 8. The capture tool may be, for example, capture tool 360 of FIG. 3B.

FIG. 10 shows a process for creating digest files in accordance with an illustrative embodiment of the present invention. A preprocessor, for example preprocessor 350 of FIG. 3A, may execute some of the process steps. Initially, preprocessor receives a test case (step 1001). Preprocessor then receives source reference files associated with the test case (step 1003). Preprocessor, for all files, adds a unique identifier to each instance of each output phrase (step 1005). The unique identifier may include a combination of source reference file number, a separator, and a phrase number. Any symbol may be substituted for a number, so long as the number or symbol is unique within its context. That is, within the context of a file, each phrase number must be unique as applied to each instance. If the source reference files require compiling prior to becoming executable, preprocessor may build application with modified reference source files (step 1006). Preprocessor executes the test case (step 1007). Such execution may directly use the modified source reference files or run an application built in step 1006.

Next, a capture tool captures a resulting image (step 1009). A resulting image may be, for example, resulting image 800 of FIG. 8. The capture tool stores the resulting image in a digest file (step 1011). Alternatively, the capture tool may store a file reference to the resulting image in a digest file and store the actual resulting image elsewhere. The digest file may be, for example, digest file 900 of FIG. 9. Step 1005 creates distinct unique identifiers for each instance of a word or output phrase. For example, close 707, and close 703 receive unique identifiers 1.5 and 1.9, respectively of FIG. 7.

The capture tool continues by extracting each instance of output phrases from the running application (step 1013). Extracting each instance is performed before or after aspects of a resulting image are rendered to, for example, graphics adapter 218 of FIG. 2. The outcome of extracting is to obtain one or more instances of output phrases as text, for example, as a string of ASCII characters. Furthermore, the capture tool derives an instance of an output phrase from executed source file commands. For example, the processor may execute compiled code originating as a modified source reference file thereby commanding a graphics adapter to render or otherwise obtain a resulting image.

One way a capture tool extracts is to optically character recognize, or scan, text that is contained within the resulting image to arrive at instances accompanied by unique identifiers. A second way a capture tool extracts is to introspect the running application.

Introspection may be accomplished in an object oriented application environment. A widget presents each portion of a panel or dialog box where text is presented. A widget is an object that contains both methods and data for displaying or otherwise rendering text in a graphics adapter. In essence, in this illustrative embodiment, the capture tool queries all visible widgets asking for the data stored therein concerning text being displayed. Each widget then provides the strings of text that the graphics displays. The capture tool records the information as described earlier. In other words, a widget may be a file of source file commands associated with the modified source reference file.

The capture tool appends each instance of the output phrase to the digest file (step 1017). The appending step includes adding the unique identifier associated with the instance to the digest file. Because preprocessor added unique identifiers in step 1005, some instances may be compound instances. That is, a first output phrase may reference a second output phrase as a substitute text to incorporate into the first output phrase. A processor tests to see if more test cases remain (step 1019). If more test cases remain, processing resumes by continuing steps beginning with receiving a test case (step 1001). If no more test cases remain, the process stops. When the process stops, there is a database of one or more digests available for later search and retrieval, including indexes or unique identifiers for each instance of each output phrase.

Thus, a preprocessor, together with the application and the capture tool, amplifies each instance of an output phrase so that later searching may be done to find a single source reference file, rather than a confusing group of instances of the same output phrase appearing in varying contexts.

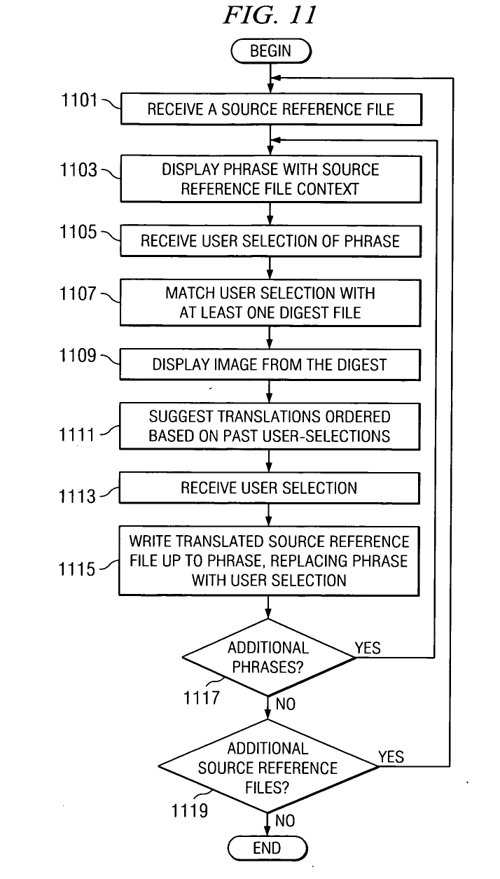

FIG. 11 shows a process for collecting a user's translations of a source reference file in accordance with an illustrative embodiment of the present invention. A matchtool receives a source reference file (step 1101). The source reference file may be, for example, java file 700 of FIG. 7. The matchtool may be, for example, matchtool 401 of FIG. 4A.

Matchtool 401 may display each instance of the output phrase in order, optionally showing any surrounding instructions, if any, of the source reference file as ellipsis. Alternatively, matchtool 401 displays a portion of the source reference file. In this alternative matchtool 401 shows that portion of the source reference file that includes the current instance of the current output phrase. That is, matchtool 401 displays the output phrase with source reference file context (step 1103). In this step, the matchtool may display the source reference file having an unselected instance of the instance of the output phrase. One or more instances of output phrases may be visible to a user in this situation. Matchtool 401 receives a user selection of an instance of the output phrase (step 1105). Receiving the user selection includes receiving a user-selected instance wherein a user moves a pointing device proximal to the unselected instance. A pointing device may be a mouse, for example, connected to keyboard and mouse adapter 220 of FIG. 2. Alternatively, receiving the user selection includes a user typing the output phrase, or a unique identifier of an instance of the output phrase or portions thereof.

Matchtool 401 matches the user-selected instance of the output phrase with a digest file (step 1107). A user-selected instance of the output phrase is a user selection. Step 1107 includes matchtool 401 looking up the instance in a digest database, wherein the digest database may be several digest files. Looking up includes identifying a single digest file having an image. Matchtool 401 displays the image from the digest database (step 1109). The image is associated with the instance. Machtool 401 may find multiple digests that include the instance. Matchtool 401 will show all images that use the instance, but will not show additional images that use an identical word or phrase but are a separate instance, provided, that the first instance does not also appear in the additional images.

If translator had translated another instance of the output phrase, matchtool 401 may suggest translations ordered based on past user-selections (step 1111). Step 1111 may include retrieving the translation input, formerly given, in response to receiving the user-selected instance. Sometimes there may be two different translations for a string, for example, close-near and close-cease-and-put-away. When there are two formerly given responses, matchtool 401 will receive a user selection of one of the formerly given responses (step 1113). Alternatively, if no former response applies, a matchtool 401 may receive a user translation input or user selection wherein the user enters a translation text to a search field.

In an alternative embodiment, matchtool 401 may present a source reference file in an editor, permitting edits of only the output phrases, and in particular, of the output phrase a user selected for context.

Matchtool 401 writes a translated source reference file up to the output phrase, and then replaces the phrase with the user selection or user translation input (step 1115).

Matchtool 401 checks to see if additional output phrases exist in the file (step 1117). If additional output phrases exist, matchtool 401 continues with step 1103. If not, matchtool 401 checks to see if additional source reference files remain (step 1119). If additional source reference files remain, matchtool 401 continues with step 1101. Otherwise processing ends.

As mentioned, a user may make a user selection or user translation input by entering an output phrase to a field. One way for a translator to identify uniquely the search for context, is for the translator to enter the unique identifier of the instance of the output phrase. In that case, matchtool 401 receives a numeric entry. Alternatively, a user may select an output phrase by just entering the non-numeric entry portion of the instance.

Thus, a digest database is provided and a corresponding matchtool is shown to assist a translator to locate the specific instance of an output phrase and display an example of the output phrase used in a graphical user interface so that a translator is not overwhelmed with irrelevant contexts for translation.

A symbol may include one or more characters from a conventional computer's character set. Thus a unique identifier that consists of an instance number may be, for example, “1a2b3c5”.

The invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the present invention for various embodiments with various modifications as are suited to the particular use contemplated.

What is claimed is:

1. A computer implemented method for associating a user interface image with an instance of an output phrase, the computer implemented method comprising:
adding a unique identifier to each instance of an output phrase in a source reference file to form a modified source reference file associated with source file commands to render each instance of the output phrase;
executing the modified source reference file to obtain a resulting image having a graphical representation of the instance;
storing the resulting image in a digest file;
deriving an instance of an output phrase from executed source file commands, the instance having a derived unique identifier; and
appending the derived unique identifier of the instance of the output phrase to the digest file.

2. The computer implemented method of claim 1, wherein the derived unique identifier comprises a file identifier and an instance of the output phrase identifier.

3. The computer implemented method of claim 1, wherein adding comprises appending the instance of the output phrase and the unique identifier to the digest file.

4. The computer implemented method of claim 1, wherein storing comprises storing a file reference to the resulting image in a digest file.

5. The computer implemented method of claim 1, wherein executing comprises building the modified source reference file and executing machine instructions; and wherein executed source file commands are executed machine instructions.

6. The computer implemented method of claim 1, wherein the executed source file commands comprise a widget.

7. A computer implemented method for providing contextual assistance for a user-selected instance of an output phrase comprising:
looking up the user-selected instance in a digest database; and
displaying an image associated with the instance.

8. The computer implemented method of claim 7, wherein displaying comprises displaying-one image associated with the instance.

9. The computer implemented method of claim 8 further comprising:
displaying a source reference file having an unselected instance of the output phrase; and
receiving a user-selected instance wherein a user moves a pointing device proximal to the unselected instance.

10. The computer implemented method of claim 8 further comprising:
receiving a user translation input; and
writing the user translation input to a translated source reference file.

11. The computer implemented method of claim 9 further comprising:
retrieving the user translation input, in response to receiving the user-selected instance.

12. The computer implemented method of claim 9, wherein receiving a user-selected instance comprises receiving non-numeric entry.

13. The computer implemented method of claim 9, wherein receiving a user-selected instance comprises receiving a numeric entry.

14. A computer program product comprising a computer usable medium having computer usable program code for providing contextual assistance for a user-selected instance of an output phrase, said computer program product including;
computer usable program code for looking up the instance in a digest database; and
computer usable program code for displaying an image associated with the instance.

15. The computer program product of claim 14, wherein computer usable program code for displaying an image associated with the instance comprises computer usable program code for displaying one image associated with the instance.

16. The computer program product of claim 15 further comprising:
computer usable program code for displaying a source reference file having the instance of the output phrase; and
computer usable program code for receiving a user-selected instance wherein a user moves a pointing device proximal to the instance.

17. The computer program product of claim 15 further comprising:
computer usable program code for receiving a user translation input; and
computer usable program code for writing the user translation input to a translated source reference file.

18. The computer program product of claim 16 further comprising:
computer usable program code for retrieving the user translation input responsive to computer usable program code for receiving the user-selected instance.

19. The computer program product of claim 16, wherein computer usable program code for receiving a user-selected instance comprises computer usable program code for receiving non-numeric entry.

20. The computer program product of claim 16, wherein computer usable program code for receiving a user-selected instance comprises computer usable program code for receiving a numeric entry.
